(19) United States
(12) Patent Application Publication
(10) Pub. No.: US 2026/0351698 A1
(43) Pub. Date: Nov. 5, 2026

(54) BATTERY CHARGING CONTROL METHOD, ENERGY STORAGE DEVICE, STORAGE MEDIUM

(71) Applicant: SHENZHEN HELLO TECH ENERGY CO., LTD, Shenzhen (CN)

(72) Inventors: Wenqun LI, Shenzhen (CN); Xinxin AN, Shenzhen (CN); Qian ZHOU, Shenzhen (CN); Jichang WU, Shenzhen (CN); Zhijie LIU, Shenzhen (CN); Gaosong SHEN, Shenzhen (CN); Zhongwei SUN, Shenzhen (CN)

(21) Appl. No.: 19/726,862

(22) Filed: Jun. 30, 2026

Related U.S. Application Data
(63) Continuation of application No. PCT/CN2026/098980, filed on May 25, 2026.

(30) Foreign Application Priority Data
Jun. 10, 2025 (CN) 202510772428.6

(51) Int. Cl. H01M 10/44; H01M 10/48; H02J 7/61; H02J 7/65; H02J 7/90

(52) U.S. Cl. CPC H01M 10/443; H01M 10/486; H02J 7/61; H02J 7/65; H02J 7/977

(57) ABSTRACT

A battery charging control method is provided. The method includes: obtaining a temperature of a battery; in response to a temperature of the battery being within a first temperature range, determining a charging strategy switching point based on a predetermined temperature hysteresis value and a range junction point; when the temperature of the battery changes from the first temperature range to the second temperature range, charging the battery at a second charging rate in response to the temperature of the battery crossing one of the range junction point or the charging strategy switching point; and when the temperature of the battery changes from the second temperature range to the first temperature range, charging the battery at a first charging rate in response to the temperature of the battery crossing another one of the range junction point or the charging strategy switching point.

### CROSS-REFERENCE TO RELATED APPLICATION

This application is a continuation of International Patent Application No. PCT/CN2026/098980, filed on May 25, 2026, which claims priority to and the benefit of Chinese patent application No. 202510772428.6 filed with China National Intellectual Property Administration on Jun. 10, 2025, the entire contents of which are incorporated herein by reference.

### FIELD

The present disclosure relates to the field of energy storage control technologies, and more particularly, to a battery charging control method, an energy storage device, and a non-transitory computer-readable storage medium.

### BACKGROUND

An energy storage device is vital in the energy field. The energy storage device can store and release electric energy, effectively balance a supply-demand relationship in a power system, and improve stability and reliability of the power system. Also, the energy storage device can optimize the energy utilization efficiency by storing and regulating energy from intermittent renewable energy sources such as solar energy and wind energy, enabling the energy sources to be connected to a power grid in a more stable manner, thereby reducing energy waste. Therefore, large-scale application of clean energy can be promoted.

Charging is an essential link for the energy storage device to store energy. An efficient and safe charging mode can ensure that the energy storage device stores the electric energy rapidly and stably, prolonging a service life of energy storage device, and lowering an operation cost.

It was realized that when a temperature of the energy storage device repeatedly rises and falls, a conventional battery charging control method may continuously and repeatedly adjust a charging strategy, which may seriously impair charging stability and cause thermal runaway.

### SUMMARY

The present disclosure aims to solve at least one of the technical problems in the related art. To this end, the present disclosure provides a battery charging control method, an energy storage device, and a non-transitory computer-readable storage medium, which is capable of avoiding frequent changes of a charging strategy caused by fluctuations of a current temperature of the battery, maintaining charging stability, thereby reducing a risk of thermal runaway and prolonging a service life of the energy storage device.

In a first aspect, the battery charging control method provided by the present disclosure includes: obtaining a temperature of a battery; charging the battery at a first charging rate in response to the temperature of the battery being within a first temperature range, and charging the battery at a second charging rate in response to the temperature of the battery being within a second temperature range, the first temperature range and the second temperature range being adjacent to each other and sharing a range junction point, and the first charging rate being different from the second charging rate; determining, in response to the temperature of the battery being within the first temperature range, a charging strategy switching point based on a predetermined temperature hysteresis value and the range junction point; and charging, when the temperature of the battery changes from the first temperature range to the second temperature range, the battery at the second charging rate in response to the temperature of the battery crossing one of the range junction point or the charging strategy switching point; and charging, when the temperature of the battery changes from the second temperature range to the first temperature range, the battery at the first charging rate in response to the temperature of the battery crossing another one of the range junction point or the charging strategy switching point.

In a second aspect, the energy storage device provided by the present disclosure includes: a memory; a processor; and a computer program stored in the memory and executable on the processor. The processor is configured to, when executing the program, implement the battery charging control method according to the above.

In a third aspect, the non-transitory computer-readable storage medium provided by the present disclosure has a computer program stored thereon. The computer program is configured to, when executed by a processor, implement the battery charging control method according to the above.

In the battery charging control method, the energy storage device, and the non-transitory computer-readable storage medium according to the embodiments of the present disclosure, charging can be performed at a corresponding charging rate based on a temperature range where the temperature of the battery falls. When the temperature of the battery is within the first temperature range and changes towards the second temperature range, the charging strategy switching point is set based on the predetermined temperature hysteresis value and the first temperature range, so that the charging rate is switched when the temperature of the battery crosses the range junction point or the charging strategy switching point.

When the charging strategy switching point is adopted for the temperature of the battery changing from the first temperature range to the second temperature range, the charging rate is switched via the range junction point when the temperature of the battery changes from the second temperature range to the first temperature range. When the range junction point is adopted for the temperature of the battery changing from the first temperature range to the second temperature range, the charging rate is switched via the charging strategy switching point when the temperature of the battery changes from the second temperature range to the first temperature range.

In this way, it is avoided that switching is performed at the same temperature when the temperature of the battery fluctuates between the first temperature range and the second temperature range, frequent changes of the charging rate caused by fluctuations of the temperature of the battery are prevented, and the charging stability of the battery can be maintained. Therefore, the risk of thermal runaway can be reduced, and the service life of the battery can be prolonged.

Additional aspects and advantages of the embodiments of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a schematic diagram of an application scenario of a battery charging control method according to an embodiment of the present disclosure.

FIG. 2 is a first schematic flowchart of a battery charging control method according to an embodiment of the present disclosure.

FIG. 3 is a second schematic flowchart of a battery charging control method according to an embodiment of the present disclosure.

FIG. 4 is a third schematic flowchart of a battery charging control method according to an embodiment of the present disclosure.

FIG. 5 is a fourth schematic flowchart of a battery charging control method according to an embodiment of the present disclosure.

FIG. 6 is a fifth schematic flowchart of a battery charging control method according to an embodiment of the present disclosure.

FIG. 7 is a schematic diagram illustrating a comparison of a charging current and a charging temperature between an implementation of the present disclosure and a comparative example.

FIG. 8 is a schematic diagram illustrating modules a battery charging control apparatus according to an embodiment of the present disclosure.

FIG. 9 is a schematic structural diagram of an energy storage device according to an embodiment of the present disclosure.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative, and are intended to explain, rather than limiting, the present disclosure.

For ease of understanding, the technical background and an application scenario of the present disclosure are introduced first as follows.

A battery plays a vital role in many aspects of social production and daily life. With the battery, excess energy can be stored during periods of energy surplus, and electric energy can be released to an electric load when energy is insufficient. As a backup power supply, the battery can provide emergency power for a critical device, household appliances, and the like, guaranteeing basic operation of society and people's daily lives, and reducing a property loss caused by a power outage. Also, the battery can improve an energy utilization efficiency and advance the development of distributed energy sources.

Charging is the primary way for the battery to obtain energy. Through timely and effective charging, the battery can store sufficient electric energy, to discharge normally when needed, supply power support for various applications, and ensure continuous and stable operation of the battery.

However, in a conventional battery charging control method, charging is performed under a corresponding high-power or high-current mode based on the temperature of the battery, and the corresponding high power or high current is distributed in a stepped manner. When a temperature change meets a predetermined requirement, the corresponding high-power or high-current mode needs to be switched. Due to external ambient conditions, heat dissipation by a fan, and other factors, the temperature of the battery may alternately rise and fall, which may cause a battery charging strategy to switch continuously, resulting in frequent pulse charging.

Frequent pulse charging may cause repeated expansion and contraction of the electrode material of the battery, and gradually cause shedding and structural damage of the electrode material, thereby reducing the capacity of the battery and affecting performance of the battery, such that aging of the battery is accelerated, impairing battery stability, and shortening the service life of the battery. Frequent pulse charging may also lead to accumulation of heat inside the battery and a rise in the temperature of the battery, which may degrade battery performance and safety. In addition, an excessively high temperature may even trigger safety hazards such as thermal runaway.

With a battery charging control method according to the present disclosure, charging is performed at a charging rate corresponding to a temperature range where the temperature of the battery falls. When the temperature of the battery is within a first temperature range and changes towards a second temperature range, a charging strategy switching point is set based on a predetermined temperature hysteresis value and the first temperature range, so that a charging rate is switched when the temperature of the battery crosses a range junction point or the charging strategy switching point.

When the charging strategy switching point is adopted for the temperature of the battery changing from the first temperature range to the second temperature range, the charging rate is switched via the range junction point when the temperature of the battery changes from the second temperature range to the first temperature range. When the range junction point is adopted for the temperature of the battery changing from the first temperature range to the second temperature range, the charging rate is switched via the charging strategy switching point when the temperature of the battery changes from the second temperature range to the first temperature range.

In this way, it is avoided that switching is performed at the same temperature when the temperature of the battery fluctuates between the first temperature range and the second temperature range, frequent changes of the charging rate caused by fluctuations of the temperature of the battery are prevented, and charging stability of the battery can be maintained. Therefore, the risk of thermal runaway can be reduced, and the service life of the battery can be prolonged.

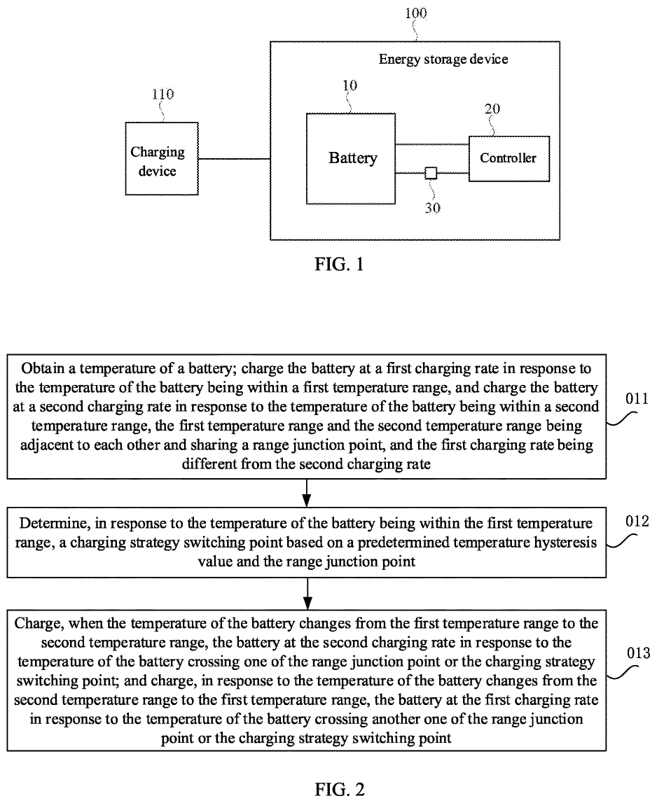

FIG. 1 is a schematic diagram of an application scenario of a battery charging control method according to an embodiment of the present disclosure. As illustrated in FIG. 1, the application scenario according to the present disclosure includes an energy storage device 100 and a charging device 110. The energy storage device 100 includes a battery 10, a controller 20, and a temperature collecting assembly 30. The battery charging control method according to the present disclosure may be implemented by the controller 20.

The energy storage device 100 is configured to store and release energy. The energy storage device 100 is connected to the charging device 110 to receive electric energy from the charging device 110. The energy storage device 100 may be connected to an electric load and supply electric energy to the electric load to realize normal operation of the electric load.

In some embodiments, the energy storage device 100 includes a lithium-ion battery, a lead-acid battery, a nickel-metal hydride battery, a portable energy storage product (such as a smart phone, a tablet computer, a notebook computer, etc.), a household energy storage battery, a vehicle power battery, and the like, which are not limited in the embodiments of the present disclosure.

The charging device 110 is configured to supply electric energy to the energy storage device 100. The charging device 110 is capable of supplying an appropriate alternating current or direct current to the energy storage device 100. In some embodiments, the charging device 110 may be a combination of a charging pile (a direct current or an alternating current charging pile) and a power grid, a mobile power supply, a combination of a charger (a fast-charging charger, a multi-port charger, an intelligent charger) and a power socket, and the like, which are not limited in the embodiments of the present disclosure.

The battery 10 is configured to realize mutual conversion between chemical energy and the electric energy. The battery 10 converts the electric energy supplied by the charging device 110 to the energy storage device 100 into the chemical energy for storage, and convert the chemical energy into the electric energy for power supply to the electric load when the energy storage device 100 is required to discharge.

In some embodiments, the battery 10 may be a battery pack, a battery module (a battery assembly unit formed by combining a plurality of battery cells in series, parallel, or hybrid connection), or a battery cell. The battery 10 may be a lithium-ion battery, a lead-acid battery, a nickel-metal hydride battery, and the like, which are not limited in the embodiments of the present disclosure.

The controller 20 is a device with data processing capability. The controller 20 is connected to the battery 10 and the temperature collecting assembly 30, and is configured to control operation of the battery 10 and the temperature collecting assembly 30 to realize charging control of the battery 10.

In some embodiments, the controller 20 may be a Battery Management System (BMS), a Microcontroller Unit (MCU), a single-chip microcomputer, a System on Chip (SoC), a Field Programmable Gate Array (FPGA), and the like, which are not limited in the embodiments of the present disclosure.

The temperature collecting assembly 30 is configured to collect temperature information of the battery 10. The temperature collecting assembly 30 is connected to the battery 10 and the controller 20. The temperature collecting assembly 30 is configured to collect temperature information of the battery 10 under the control of the controller 20. In some embodiments, the temperature collecting assembly 30 may be connected via a wire harness to the battery 10 or directly disposed on a surface of the battery 10, among other connection modes. In some embodiments, the temperature collecting assembly 30 may be configured to collect a surface temperature or an internal temperature of the battery 10, or a temperature of each or part of the battery cells.

In some embodiments, the temperature collecting assembly 30 may be a thermocouple temperature sensor, a thermal resistance temperature detector, an NTC thermistor temperature sensor, a radiation thermometer, an infrared thermal imager, an ultrasonic thermometer, and the like, which are not limited in the embodiments of the present disclosure.

Based on the foregoing introduction of the technical background and related scenarios, an embodiment of the present disclosure provides a battery charging control method, which is described in detail below.

As illustrated in FIG. 2, the battery charging control method according to the embodiment of the present disclosure includes following step 011, step 012, and step 013, which are elaborated below.

At step 011, a temperature of a battery is obtained. The battery is charged at a first charging rate in response to the temperature of the battery being within a first temperature range. The battery is charged at a second charging rate in response to the temperature of the battery being within a second temperature range. The first temperature range and the second temperature range are adjacent to each other and share a range junction point. The first charging rate is different from the second charging rate.

The first temperature range and the second temperature range are segmented temperature ranges set on an empirical basis. For example, the first temperature range is [0 °C, 10 °C), and the second temperature range is [10 °C, 20 °C.).

Each of the first charging rate and the second charging rate is a ratio of a charging current to a rated capacity of the battery during charging, which is set on an empirical basis. For example, the first charging rate is 0.5C, and the second charging rate is 1C.

The range junction point refers to a boundary point between temperature ranges. For example, if the first temperature range is [0 °C, 10 °C) and the second temperature range is [10 °C, 20 °C), the range junction point is 10 °C.

In an exemplary embodiment of the present disclosure, the temperature of the battery is collected by the temperature collecting assembly, and charging is performed at a charging rate corresponding to a temperature range where the temperature of the battery resides. In this way, the charging efficiency can be guaranteed, and accelerated aging of the electrode material of the battery caused by high-rate charging under high or low temperature conditions can be avoided, protecting the service life of the battery.

In some embodiments, when the battery is the battery module or the battery pack, the temperature of the battery is determined based on a temperature of each battery cell inside the battery. The temperature of the battery may be an average value, a median value, a maximum value, a minimum value, or the like of temperatures of the battery cells.

At Step 012, in response to the temperature of the battery being within the first temperature range, a charging strategy switching point is determined based on a predetermined temperature hysteresis value and the range junction point.

At Step 013, when to the temperature of the battery changes from the first temperature range to the second temperature range, the battery is charged at the second charging rate in response to the temperature of the battery crossing one of the range junction point or the charging strategy switching point; when the temperature of the battery changes from the second temperature range to the first temperature range, the battery is charged at the first charging rate in response to the temperature of the battery crossing another one of the range junction point or the charging strategy switching point.

The predetermined temperature hysteresis value is a temperature difference set on an empirical basis. For example, the temperature difference may be 2 °C or 3 °C.

The charging strategy switching point is a temperature value determined based on the predetermined temperature hysteresis value and the range junction point.

In an exemplary embodiment of the present disclosure, when the charging strategy switching point is adopted for the temperature of the battery changing from the first temperature range to the second temperature range, the charging rate is switched via the range junction point when the temperature of the battery changes from the second temperature range to the first temperature range. When the range junction point is adopted for the temperature of the battery changing from the first temperature range to the second temperature range, the charging rate is switched via the charging strategy switching point when the temperature of the battery changes from the second temperature range to the first temperature range.

In this way, it is avoided that switching is performed at the same temperature when the temperature of the battery fluctuates between the first temperature range and the second temperature range, frequent changes of the charging rate caused by fluctuations of the temperature of the battery are prevented, material degradation of the battery can be reduced, and the charging stability of the battery can be maintained. Therefore, the risk of thermal runaway can be reduced, and the service life of the battery can be prolonged.

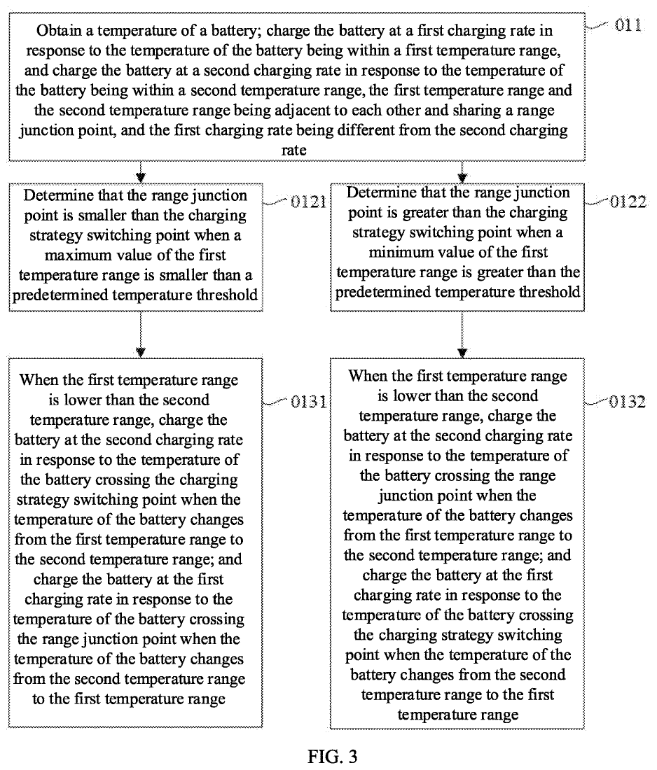

In some embodiments, as illustrated in FIG. 3, step 012 includes following steps 0121 and 0122.

At step 0121, it is determined that the range junction point is smaller than the charging strategy switching point when a maximum value of the first temperature range is smaller than a predetermined temperature threshold.

At Step 0122, it is determined that the range junction point is greater than the charging strategy switching point when a minimum value of the first temperature range is greater than the predetermined temperature threshold.

The predetermined temperature threshold is a temperature value preset on an empirical basis. For example, the temperature value may be 20 °C.

In an exemplary embodiment of the present disclosure, different magnitude relationships between the charging strategy switching point and the range junction point are adopted according to a relationship between the first temperature range and the preset temperature threshold. When the maximum value of the first temperature range is smaller than the predetermined temperature threshold, the charging strategy switching point is obtained by subtracting the predetermined temperature hysteresis value from the range junction point. When the minimum value of the first temperature range is greater than the predetermined temperature threshold, the charging strategy switching point is obtained by adding the predetermined temperature hysteresis value to the range junction point. The predetermined temperature hysteresis value is a positive value.

In this way, a corresponding magnitude relationship between the charging strategy switching point and the range junction point can be satisfied. It is avoided that switching is performed at the same temperature when the temperature of the battery fluctuates between the first temperature range and the second temperature range, improving charging stability and safety of the battery.

In some embodiments, as illustrated in FIG. 3, step 013 includes following steps 0131 and 0132.

At step 0131, when the first temperature range is lower than the second temperature range and the maximum value of the first temperature range is smaller than the predetermined temperature threshold, the battery is charged at the second charging rate in response to the temperature of the battery crossing the charging strategy switching point when the temperature of the battery changes from the first temperature range to the second temperature range; or the battery is charged at the first charging rate in response to the temperature of the battery crossing the range junction point when the temperature of the battery changes from the second temperature range to the first temperature range.

For example, under the condition that the predetermined temperature threshold is 20 °C, the first temperature range is [0 °C, 10 °C), the second temperature range is [10 °C, 20 °C), the range junction point is 10 °C, the predetermined temperature hysteresis value is 2 °C, the corresponding charging strategy switching point is 12 °C, the first charging rate is 0.5C, and the second charging rate is 1C, if the temperature of the battery gradually changes from 8 °C to 11 °C, charging is still performed at the first charging rate of 0.5C, and if the temperature of the battery gradually changes from 8 °C to 13 °C, charging is performed at the second charging rate of 1C after the temperature of the battery crosses 12 °C.

If the temperature of the battery gradually changes from 13 °C to 11 °C, charging is performed still at the second charging rate of 1C. If the temperature of the battery gradually changes from 13 °C to 8 °C, charging is performed at the first charging rate of 0.5C after the temperature of the battery crosses 10 °C.

In this way, frequent changes of the charging rate caused by fluctuations in the temperature of the battery can be avoided, the risk of thermal runaway of the battery can be reduced, and thus the charging stability and the service life of the battery are improved.

At step 0132, when the first temperature range is lower than the second temperature range and the minimum value of the first temperature range is greater than the predetermined temperature threshold, the battery is charged at the second charging rate in response to the temperature of the battery crossing the range junction point when the temperature of the battery changes from the first temperature range to the second temperature range; or the battery is charged at the first charging rate in response to the temperature of the battery crossing the charging strategy switching point in response to the temperature of the battery changes from the second temperature range to the first temperature range.

For example, under the condition that the predetermined temperature threshold is 20 °C, the first temperature range is [20 °C, 47 °C), the second temperature range is [47 °C, 50 °C), the range junction point is 47 °C, the predetermined temperature hysteresis value is 3 °C, the corresponding charging strategy switching point is 44 °C, the first charging rate is 0.8C, and the second charging rate is 0.6C, if the temperature of the battery gradually changes from 48 °C to 45 °C, charging is still performed at the second charging rate of 0.6C, and if the temperature of the battery gradually changes from 48 °C to 43 °C, charging is performed at the first charging rate of 0.8C after the temperature of the battery crosses 44 °C.

If the temperature of the battery gradually changes from 43 °C to 46 °C, charging is performed still at the first charging rate of 0.8C. If the temperature of the battery gradually changes from 43 °C to 48 °C, charging is performed at the second charging rate of 0.6C after the temperature of the battery crosses 47 °C.

In this way, it is avoided that switching is performed at the same temperature when the temperature of the battery fluctuates between the first temperature range and the second temperature range, and frequent changes of the charging rate are prevented, improving stability and safety of charging.

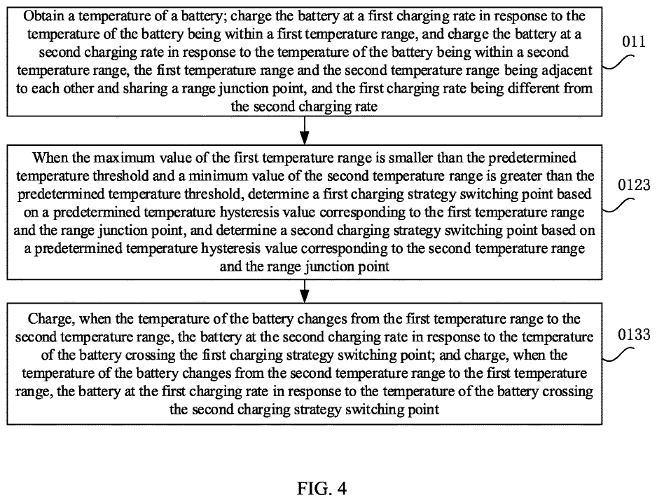

In some embodiments, as illustrated in FIG. 4, step 012 further includes step 0123, and step 013 further includes step 0133, which are described in detail below.

At step 0123, when the maximum value of the first temperature range is smaller than the predetermined temperature threshold and a minimum value of the second temperature range is greater than the predetermined temperature threshold, a first charging strategy switching point is determined based on a predetermined temperature hysteresis value corresponding to the first temperature range and the range junction point, and a second charging strategy switching point is determined based on a predetermined temperature hysteresis value corresponding to the second temperature range and the range junction point.

At step 0133, when the temperature of the battery changes from the first temperature range to the second temperature range, the battery is charged at the second charging rate in response to the temperature of the battery crossing the first charging strategy switching point; when the temperature of the battery changes from the second temperature range to the first temperature range, the battery is charged at the first charging rate in response to the temperature of the battery crossing the second charging strategy switching point.

In an exemplary embodiment of the present disclosure, when the first temperature range and the second temperature range are divided by the predetermined temperature threshold (for example, the range junction point is the predetermined temperature threshold), two charging strategy switching points are determined corresponding to the first temperature range and the second temperature range, respectively, since the predetermined temperature threshold is passed. In this way, a temperature gap for switching between the first charging rate and the second charging rate can be further widened, and frequent switching of the charging rate caused by temperature fluctuations can be reduced.

In some embodiments, the maximum value of the first temperature range is smaller than (or equal to) the predetermined temperature threshold, or the minimum value of the second temperature range is greater than (or equal to) the predetermined temperature threshold.

For example, under the condition that the predetermined temperature threshold is 20 °C, the first temperature range is [10 °C, 20 °C), the second temperature range is [20 °C, 47 °C), the range junction point is 20 °C, the predetermined temperature hysteresis value corresponding to the first temperature range is 2 °C, the predetermined temperature hysteresis value corresponding to the second temperature range is 3 °C, the first charging strategy switching point is 22 °C, the second charging strategy switching point is 17 °C, the first charging rate is 1C, and the second charging rate is 0.8C, if the temperature of the battery gradually changes from 16 °C to 21 °C, charging is performed still at the first charging rate of 1C, and if the temperature of the battery gradually changes from 16 °C to 23 °C, charging is performed at the second charging rate of 0.8C after the temperature of the battery crosses 22 °C.

If the temperature of the battery gradually changes from 23 °C to 18 °C, charging is performed still at the second charging rate of 0.8C. If the temperature of the battery gradually changes from 23 °C to 16 °C, charging is performed at the first charging rate of 1C after the temperature of the battery crosses 17 °C.

In this way, frequent changes of the charging rate caused by fluctuations in the temperature of the battery can be avoided, and the risk of thermal runaway of the battery can be significantly reduced, improving the stability and safety of charging.

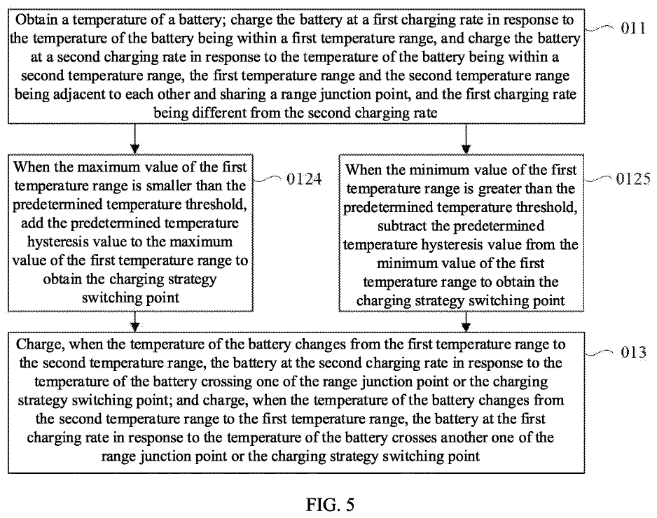

In some embodiments, as illustrated in FIG. 5, step 012 further includes following steps 0124 and 0125.

At step 0124, when the maximum value of the first temperature range is smaller than the predetermined temperature threshold, the predetermined temperature hysteresis value is added to the maximum value of the first temperature range to obtain the charging strategy switching point.

In an exemplary embodiment of the present disclosure, herein, the maximum value of the first temperature range may be understood as the range junction point. The second temperature range is higher than the first temperature range. A temperature closer to the predetermined temperature threshold corresponds to a higher charging rate. That is, the second charging rate is greater than the first charging rate. When the temperature changes from the first temperature range towards the second temperature range, the charging rate needs to be increased accordingly. Nevertheless, an excessively high charging rate may cause severe lithium precipitation of the battery and impair the service life of the battery. Therefore, when the battery is switched from a lower charging rate to a higher charging rate, the charging strategy switching point is obtained by adding the predetermined temperature hysteresis value to the maximum value of the first temperature range. In this way, the battery can only switch to the higher charging rate at a higher temperature, which may delay entry into the high charging rate and thus improve the service life of the battery.

At step 0125, when the minimum value of the first temperature range is greater than the predetermined temperature threshold, the predetermined temperature hysteresis value is subtracted from the minimum value of the first temperature range to obtain the charging strategy switching point.

In an exemplary embodiment of the present disclosure, herein, the minimum value of the first temperature range may be understood as the range junction point. The second temperature range is lower than the first temperature range. The second charging rate is greater than the first charging rate. At a relatively high temperature (i.e., higher than the predetermined temperature threshold), when the temperature of the battery changes from the first temperature range towards the second temperature range, a corresponding increase of the charging rate may accelerate aging of the electrode material of the battery and affect the service life of the battery. Therefore, when the battery is switched from the lower charging rate to the higher charging rate, the charging strategy switching point is obtained by subtracting the predetermined temperature hysteresis value from the minimum value of the first temperature range. In this way, the battery can only switch to the higher charging rate at a lower temperature, which may delay entry into the high charging rate and improve the service life of the battery.

In an exemplary embodiment of the present disclosure, corresponding methods are adopted to determine the charging strategy switching point for the relatively low temperature (i.e., lower than the predetermined temperature threshold) and the relatively high temperature (i.e., higher than the predetermined temperature threshold) according to different temperature ranges where the temperature of the battery resides.

For example, under the condition that the predetermined temperature threshold is 20 °C and the predetermined temperature hysteresis value is 3 °C, if the first temperature range is [−10 °C, 0 °C], whose maximum value 0 °C is smaller than 20 °C, the charging strategy switching point is 3 °C. When the temperature of the battery rises from the first temperature range to above 3 °C, charging is performed at the second charging rate corresponding to the second temperature range after the temperature of the battery crosses 3 °C.

If the first temperature range is [47 °C, 50 °C), whose minimum value 47 °C is greater than 20 °C, the charging strategy switching point is 44 °C. When the temperature of the battery drops from the first temperature range to below 44 °C, charging is performed at the second charging rate corresponding to the second temperature range after the temperature of the battery crosses 44 °C. In this way, frequent changes of the charging rate caused by fluctuations in the temperature of the battery can be prevented, the risk of thermal runaway can be reduced, and the service life of the battery can be prolonged.

In some embodiments, a temperature range where the temperature of the battery resides includes a plurality of third temperature ranges and a plurality of fourth temperature ranges. The first temperature range is any one of the plurality of third temperature ranges or any one of the plurality of fourth temperature ranges. A smaller difference between an average value of the third temperature range and the predetermined temperature threshold corresponds to a smaller predetermined temperature hysteresis value. A smaller difference between an average value of the fourth temperature range and the predetermined temperature threshold corresponds to a larger predetermined temperature hysteresis value.

The third temperature range and the fourth temperature range are segmented temperature ranges set on an empirical basis. The third temperature range and the fourth temperature range do not intersect. The second temperature range is a third temperature range or a fourth temperature range adjacent to the first temperature range.

The average value of the third temperature range refers to an average value of a maximum value and a minimum value of the third temperature range, or an average value of boundary values of the third temperature range. For example, if the third temperature range is [0 °C, 10 °C], an average value thereof is 5 °C. If the third temperature range is (0 °C, 10 °C], [0 °C, 10 °C), or (0 °C, 10 °C), the average value thereof is also 5 °C.

A manner for determining the average value of the fourth temperature range is similar to that for determining the average value of the third temperature range, which will not be repeated herein to avoid redundancy.

In an exemplary embodiment of the present disclosure, a smaller average value of the third temperature range relative to the predetermined temperature threshold corresponds to a lower third temperature range. The battery may suffer severe temperature fluctuations at a low temperature, and thus a larger predetermined temperature hysteresis value is adopted.

Similarly, a larger average value of the fourth temperature range relative to the predetermined temperature threshold corresponds to a higher fourth temperature range. The battery may suffer severe temperature fluctuations at a high temperature, and thus the larger predetermined temperature hysteresis value is adopted.

For example, when the predetermined temperature threshold is 20 °C, if the third temperature range is [−10 °C, 0 °C), a corresponding predetermined temperature hysteresis value is 3 °C. If the third temperature range is [0 °C, 10 °C), the corresponding predetermined temperature hysteresis value is 2 °C. If the fourth temperature range is [20 °C, 47 °C), a corresponding predetermined temperature hysteresis value is 3 °C. If the fourth temperature range is [50 °C, 52 °C), the corresponding predetermined temperature hysteresis value is 2 °C.

In this way, by increasing difficulty of switching the temperature range where the temperature of the battery resides, the risk of thermal runaway can be reduced.

In some embodiments, a ratio of the predetermined temperature hysteresis value to a range length of the first temperature range is a predetermined ratio ranging from 0.25 to 0.5. The range length is a difference between the maximum value of the first temperature range and the minimum value of the first temperature range.

The predetermined ratio is a ratio value set on an empirical basis.

In an exemplary embodiment of the present disclosure, when the temperature of the battery deviates substantially from the first temperature range and enters the second temperature range by a large margin, if the battery is still charged at the first charging rate, the charging efficiency of the battery may be reduced or overcharging of the battery may occur.

For example, under the condition that the predetermined temperature threshold is 20 °C, the first temperature range is [0 °C, 10 °C), and the second temperature range is [10 °C, 20 °C), if the predetermined temperature hysteresis value is 8 °C, the charging strategy switching point is 18 °C, when the temperature of the battery rises from 8 °C to 15 °C and the first charging rate is smaller than the second charging rate, charging is performed still at the lower first charging rate over an excessively long temperature range, which may reduce the charging efficiency.

Therefore, by limiting the ratio of the predetermined temperature hysteresis value to the range length of the first temperature range to the predetermined ratio, reduction in the charging efficiency of the battery and overcharging of the battery can be avoided.

In some embodiments, the predetermined temperature hysteresis value ranges from 1 °C to 5 °C.

In an exemplary embodiment of the present disclosure, a value range is set for the predetermined temperature hysteresis value, which may avoid an excessively large gap between the charging strategy switching point corresponding to the first temperature range and the range junction point. Otherwise, switching to the second charging rate cannot be performed in a timely manner, and the charging efficiency of the battery may be significantly reduced. Also, an excessively small predetermined temperature hysteresis value is avoided, to avoid frequent switching of the charging rate, which can further lead to pulse charging, reducing the stability and safety of the battery, and shortening the service life when the temperature of the battery fluctuates.

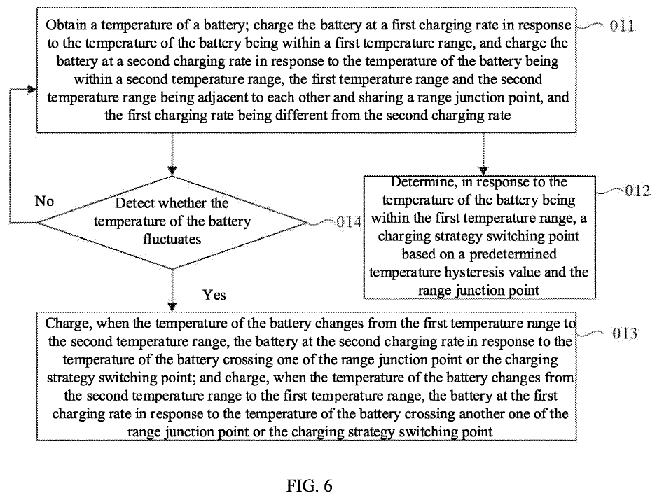

In some embodiments, as illustrated in FIG. 6, the battery charging control method further includes following step 014, which is described in detail below.

At step 014, whether fluctuation occurs in the temperature of the battery is detected.

If fluctuation occurs in the temperature of the battery, step 012 is executed. If no fluctuation occurs in the temperature of the battery, step 011 is executed.

In an exemplary embodiment of the present disclosure, temperature fluctuation refers to a scenario where a magnitude relationship between a current temperature of the battery and a historical temperature of the battery keeps changing within a certain period of time. The historical temperature of the battery refers to a temperature of the battery obtained before a current time instant. In some embodiments, the historical temperature of the battery may be a temperature of the battery obtained at a previous time instant, or determined based on multiple temperatures collected at multiple previous time instants, such as an average value of the multiple temperatures collected at multiple previous time instants.

When no fluctuation exists in the temperature of the battery, charging is performed at the corresponding first charging rate or second charging rate based on the first temperature range or the second temperature range where the temperature of the battery residues, which can maintain the charging efficiency while ensuring safety.

When the temperature of the battery fluctuates, the charging strategy switching point is set based on the range junction point and the predetermined temperature hysteresis value. When the charging strategy switching point is adopted for the temperature of the battery changing from the first temperature range to the second temperature range, the charging rate is switched via the range junction point when the temperature of the battery changes from the second temperature range to the first temperature range.

If the temperature of the battery fluctuates and the range junction point is adopted for the temperature of the battery changing from the first temperature range to the second temperature range, the charging rate is switched via the charging strategy switching point when the temperature of the battery changes from the second temperature range to the first temperature range. In this way, safety and stability of charging of the energy storage device can be improved, extending a cycling service life of the energy storage device, albeit with a slight reduction in the charging efficiency.

In this way, the charging efficiency and safety of the battery can be balanced, and the service life of the energy storage device can be prolonged.

In some embodiments, as illustrated in FIG. 6, the battery charging control method further includes following step 015, which is described in detail below.

At step 015, charging is stopped when the temperature of the battery is smaller than a first temperature threshold, or greater than or equal to a second temperature threshold. The first temperature threshold is smaller than the second temperature threshold.

The first temperature threshold and the second temperature threshold are temperature values set on an empirical basis. For example, the first temperature threshold is −10 °C. The second temperature threshold 52 °C.

In an exemplary embodiment of the present disclosure, when the temperature of the battery is excessively low and charging of the battery is continued, such an excessively low temperature may slow down a chemical reaction rate inside the battery, prolonging a charging duration, and severely reducing the charging efficiency. In addition, aging and deformation of an electrode plate in the battery may occur, thereby shortening the cycling service life of the battery. Further, when the battery is the lithium-ion battery, continuous charging at an excessively low temperature may increase a risk of lithium precipitation, and thus metallic lithium precipitates on an electrode surface of the battery, which may further trigger an internal short circuit inside the battery, seriously impairing performance and safety of the battery. Therefore, charging is stopped when the temperature of the battery is lower than the first temperature threshold.

When the temperature of the battery is excessively high and charging of the battery is continued, such an excessively high temperature may accelerate an internal chemical reaction of the battery, decompose an electrolyte inside the battery, and age the electrode material, shortening the service life of the battery. Moreover, the excessively high temperature may induce irreversible changes in an active substance inside the battery and reduce an available capacity of the battery. Also, continuous charging under the excessively high temperature may intensify the internal chemical reaction of the battery and generate more heat, which may easily lead to thermal runaway and even safety accidents such as fire and explosion. Therefore, charging is stopped when the temperature of the battery is greater than or equal to the second temperature threshold.

In some embodiments, the temperature of the battery is an average value of temperatures at different positions of the battery.

In some embodiments, when the temperatures at different positions of the battery are lower than the predetermined temperature threshold, the temperature of the battery is determined as a minimum value among the temperatures at different positions of the battery. When the temperatures at different positions of the battery are greater than or equal to the predetermined temperature threshold, the temperature of the battery is determined as a maximum value among the temperatures at different positions of the battery.

In an exemplary embodiment of the present disclosure, the battery may be provided with a plurality of temperature collecting apparatuses (for example, the battery includes a plurality of battery cells, and the temperature collecting apparatuses respectively correspond to the plurality of battery cells). Temperature values at multiple positions may be collected at the current time instant. An average value of the temperature values collected at the current time instant may be determined as the current temperature of the battery.

In some embodiments, a median value, a minimum value, a maximum value of the temperature values collected at the current time instant, or a weighted average value calculated by assigning corresponding weights may be determined as the current temperature of the battery.

In some embodiments, a corresponding temperature value may be selected as the current temperature of the battery according to a relationship between a range where each temperature value collected at the current time instant falls and the predetermined temperature threshold.

In this way, selection of the current temperature of the battery can be flexibly adjusted as required, improving stability of the energy storage device.

The technical solution of the present disclosure will be described in further detail below through specific embodiments.

### Implementation

A battery in the energy storage device of this implementation is a lithium iron phosphate module with a power of 640 W. The lithium iron phosphate module is formed by connecting 10 lithium iron phosphate cells in series and then in parallel. Reference may be made to Table 1, which lists setting conditions of the temperature range, the range junction point, the charging strategy, the predetermined temperature hysteresis value, the charging strategy switching point, and temperature protection for this embodiment.

TABLE 1
Settings of Temperature Range, Charging Strategy, Predetermined
Temperature Hysteresis Value for the Implementation

| | | | | Charging | |
|---|---|---|---|---|---|
| | Range | | Predetermined | strategy | |
| | junction | Charging | temperature | switching | Temperature |
| Temperature range | point | strategy | hysteresis value | point | protection |
| Smaller than −10 °C | / | Charging | / | / | Low- |
| | | disabled | | | temperature |
| −10 °C ≤ T < 0 °C | −10 °C or | Charging | Δt₁ = 3 °C | 3 °C | charging |
| | 0 °C | rate 1 | | | protection |
| 0 °C ≤ T < 10 °C | 0 °C or | Charging | Δt₂ = 2 °C | 12 °C | T_{UTP} < −10 °C; |
| | 10 °C | rate 2 | | | High- |
| 10 °C ≤ T < 20 °C | 10 °C or | Charging | Δt₃ = 2 °C | 22 °C | temperature |
| | 20 °C | rate 3 | | | charging |
| 20 °C ≤ T < 47 °C | 20 °C or | Charging | Δt₄ = 3 °C | 44 °C | protection |
| | 47 °C | rate 4 | | | T_{OTP} > 52 °C |
| 47 °C ≤ T < 50 °C | 47 °C or | Charging | Δt₄ = 3 °C | 47 °C | |
| | 50 °C | rate 5 | | | |
| 50 °C ≤ T < 52 °C | 50 °C or | Charging | Δtₙ = 2 °C | 48 °C | |
| | 52 °C | rate 6 | | | |
| Greater than 52 °C | / | Stop | / | / | |
| | | charging | | | |

The predetermined temperature threshold is 20 °C, the first temperature threshold is −10 °C, and the second temperature threshold is 52 °C. Excluding a temperature range for temperature protection, the temperature ranges [−10 °C, 0 °C), [0 °C, 10 °C), and [10 °C, 20 °C) are third temperature ranges, while the temperature ranges [20 °C, 47 °C), [47 °C, 50 °C), and [50 °C, 52 °C) are fourth temperature ranges. The first temperature range may be any one of the third temperature ranges or any one of the fourth temperature ranges. Each first temperature range has a corresponding predetermined temperature hysteresis value.

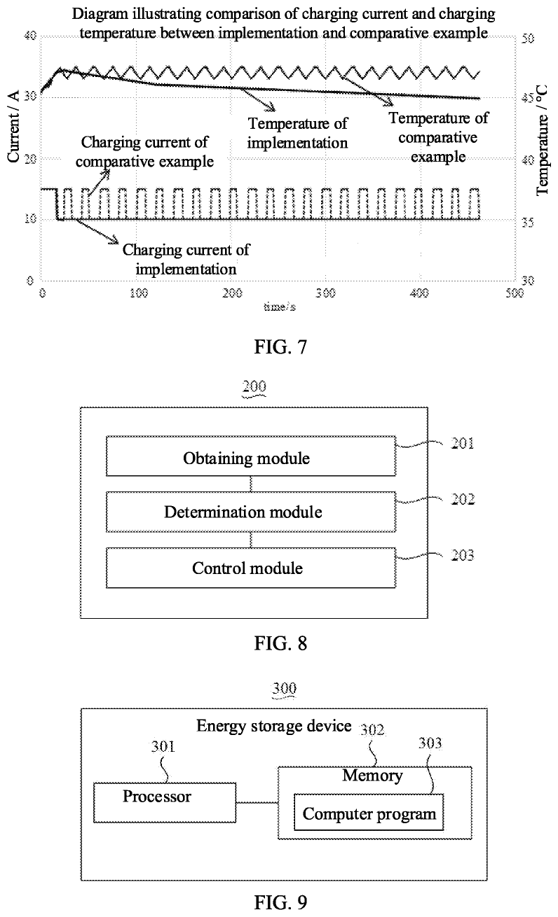

Reference may be made to FIG. 7, which is a schematic diagram illustrating a comparison of a charging current and a temperature between the implementation of the present disclosure and a comparative example.

As can be seen from FIG. 7, when the current battery temperature fluctuates around 47 °C, a charging current corresponding to the charging strategy adopted in the comparative example alternates between 15 A and 10 A, resulting in pulse charging. In this way, continuous temperature fluctuation of the battery can occur, aging of the battery can be accelerated, reducing the cycling service life and the capacity of the battery, and increasing the risk of thermal runaway.

When the temperature of the battery fluctuates around 47 °C, after the charging strategy adopted in the implementation switches the charging current from 15 A to 10 A, the temperature of the battery temporarily stops fluctuating, and the adopted charging strategy remains unchanged temporarily. Therefore, the risk of thermal runaway can be reduced, and the stability and safety of the battery can be enhanced, further prolonging the service life of the battery.

Based on the method described in the foregoing embodiments, an embodiment of the present disclosure further provides a battery charging control apparatus for implementing the steps of the above-described battery charging control method. Reference may be made to FIG. 8, which is a schematic diagram illustrating modules of a battery charging control apparatus 200 according to an embodiment of the present disclosure. The battery charging control apparatus 200 includes: an obtaining module 201, a determination module 202, and a control module 203.

The obtaining module 201 is configured to: obtain a temperature of a battery; charge the battery at a first charging rate in response to the temperature of the battery being within a first temperature range, and charge the battery at a second charging rate in response to the temperature of the battery being within a second temperature range, the first temperature range and the second temperature range being adjacent to each other and sharing a range junction point, and the first charging rate being different from the second charging rate.

The determination module 202 is configured to determine, in response to the temperature of the battery being within the first temperature range, a charging strategy switching point based on a predetermined temperature hysteresis value and the range junction point.

The control module 203 is configured to: charge, when the temperature of the battery changes from the first temperature range to the second temperature range, the battery at the second charging rate in response to the temperature of the battery crossing one of the range junction point or the charging strategy switching point; and charge, when the temperature of the battery changes from the second temperature range to the first temperature range, the battery at the first charging rate in response to the temperature of the battery crossing another one of the range junction point or the charging strategy switching point.

It should be noted that specific details of each module and unit in the above battery charging control apparatus are described in detail in the foregoing embodiments of the battery charging control method, and thus will not be repeated herein.

In the embodiments of the present disclosure, the term “module” or “unit” refers to a computer program or a portion of a computer program with a predetermined function, which cooperates with other relevant components to achieve a predetermined objective. In addition, such modules or units may be implemented in whole or in part by software, hardware (such as a processing circuit or a memory), or a combination thereof. Similarly, one processor (or multiple processors or memories) may be employed to implement one or more modules or units. In addition, each module or unit may be a part of an integrated module or unit that carries functions of the module or unit.

In some embodiments, the battery charging control apparatus according to the embodiments of the present disclosure may be implemented by hardware. For example, the apparatus may be the energy storage device or a component thereof, such as an integrated circuit or a chip. The battery charging control apparatus may also be implemented by software, for example, as an application mounted in the energy storage device.

In some embodiments, reference may be made to FIG. 9, which is a schematic structural diagram of an energy storage device according to an embodiment of the present disclosure. The energy storage device 300 includes a processor 301 and a memory 302. The memory 302 stores a computer program 303 executable on the processor 301. When the computer program 303 is configured to, when executed by the processor 301, implement each procedure of the foregoing embodiments of the battery charging control method with identical technical effects. To avoid redundancy, relevant descriptions will not be repeated herein.

The embodiments of the present disclosure further provide a non-transitory computer-readable storage medium having a computer program stored thereon. When the computer program is configured to, when executed by a processor, implement each procedure of the foregoing embodiments of the battery charging control method with identical technical effects, which will not be elaborated again to avoid repetition.

The processor may be a processor in the energy storage device described in the foregoing embodiments. The computer-readable storage medium may be a computer Read-Only Memory (ROM), a Random Access Memory (RAM), a magnetic disk, an optical disc, or the like.

The computer-readable medium may include a computer storage medium and a communication medium. The computer storage medium includes a volatile, non-volatile, removable, and non-removable medium implemented by any method or technology for storing information such as a computer-readable instruction, a data structure, a program module, or other data. The computer storage medium includes RAM, ROM, an Erasable Programmable Read-Only Memory (EPROM), an Electrically Erasable Programmable Read-Only Memory (EEPROM), a flash memory, or other solid-state memory technologies, a CD-ROM, a Digital Versatile Disc (DVD) or other optical storage media, a magnetic tape cassette, a magnetic tape, a magnetic disk storage, or other magnetic storage devices. It is apparent to those skilled in the art that a computer storage medium is not limited to the above-listed types.

The embodiments of the present disclosure further provide a computer program product including a computer program. When the computer program is configured to, when executed by a processor, implement the foregoing battery charging control method. The processor may be the processor of the energy storage device in the foregoing embodiments. When the computer program is configured to, when executed by the processor, implement each procedure of the foregoing embodiments of the battery charging control method with identical technical effects, which will not be elaborated again to avoid repetition.

It should be understood that in specific implementations of the present disclosure, data related to user identity or user attributes may be involved. When the foregoing embodiments of the present disclosure are applied to a specific product or technology, user permission or consent shall be obtained, and the collection, use, and processing of relevant data shall comply with applicable laws, regulations, and standards of relevant countries and regions.

In the description of the present disclosure, the description with reference to the terms “some embodiments,” “in an example,” and “exemplarily,” means that specific features, structures, materials, or characteristics described in conjunction with the embodiment(s) or example(s) are included in at least one embodiment or example of the present disclosure. In the present disclosure, any illustrative reference of the above terms does not necessarily refer to the same embodiment(s) or example(s). Moreover, the specific features, structures, materials, or characteristics as described can be combined in any one or more embodiments or examples as appropriate. In addition, different embodiments or examples and features of different embodiments or examples described in the specification may be combined by those skilled in the art without mutual contradiction.

Any process or method described in the flowcharts or otherwise herein may be understood as a module, a segment, or a portion of code that includes one or more executable instructions for implementing customized logical functions or steps of the process. The scope of preferred embodiments of the present disclosure includes additional implementations, where the functions may be executed not in the order shown or discussed, but in a substantially simultaneous manner or in the reverse order depending on the functions involved, as should be understood by those skilled in the art to which the embodiments of the present disclosure pertain.

Although embodiments of the present disclosure have been illustrated and described, it is conceivable for those skilled in the art that various changes, modifications, replacements, and variations can be made to these embodiments without departing from the principles and concept of the present disclosure. The scope of the present disclosure shall be defined by the claims as appended and their equivalents.

What is claimed is:

1. A battery charging control method, comprising:
obtaining a temperature of a battery; charging the battery at a first charging rate in response to the temperature of the battery being within a first temperature range, and charging the battery at a second charging rate in response to the temperature of the battery being within a second temperature range, wherein the first temperature range and the second temperature range are adjacent to each other and share a range junction point, and the first charging rate is different from the second charging rate;
determining, in response to the temperature of the battery being within the first temperature range, a charging strategy switching point based on a predetermined temperature hysteresis value and the range junction point; and
charging, when the temperature of the battery changes from the first temperature range to the second temperature range, the battery at the second charging rate in response to the temperature of the battery crossing one of the range junction point or the charging strategy switching point; and charging, when the temperature of the battery changes from the second temperature range to the first temperature range, the battery at the first charging rate in response to the temperature of the battery crossing another one of the range junction point or the charging strategy switching point.

2. The battery charging control method according to claim 1, wherein said determining, in response to the temperature of the battery being within the first temperature range, the charging strategy switching point based on the predetermined temperature hysteresis value and the range junction point comprises:
determining that the range junction point is smaller than the charging strategy switching point when a maximum value of the first temperature range is smaller than a predetermined temperature threshold; and
determining that the range junction point is greater than the charging strategy switching point when a minimum value of the first temperature range is greater than the predetermined temperature threshold.

3. The battery charging control method according to claim 2, wherein said charging, when the temperature of the battery changes from the first temperature range to the second temperature range, the battery at the second charging rate in response to the temperature of the battery crossing one of the range junction point or the charging strategy switching point; and charging, when the temperature of the battery changes from the second temperature range to the first temperature range, the battery at the first charging rate in response to the temperature of the battery crossing the other one of the range junction point or the charging strategy switching point comprises:
when the first temperature range is lower than the second temperature range and the maximum value of the first temperature range is smaller than the predetermined temperature threshold, charging the battery at the second charging rate in response to the temperature of the battery crossing the charging strategy switching point when the temperature of the battery changes from the first temperature range to the second temperature range; and charging the battery at the first charging rate in response to the temperature of the battery crossing the range junction point when the temperature of the battery changes from the second temperature range to the first temperature range.

4. The battery charging control method according to claim 2, wherein said charging, when the temperature of the battery changes from the first temperature range to the second temperature range, the battery at the second charging rate in response to the temperature of the battery crossing one of the range junction point or the charging strategy switching point; and charging, when the temperature of the battery changes from the second temperature range to the first temperature range, the battery at the first charging rate in response to the temperature of the battery crossing the other one of the range junction point or the charging strategy switching point comprises:
when the first temperature range is lower than the second temperature range and the minimum value of the first temperature range is greater than the predetermined temperature threshold, charging the battery at the second charging rate in response to the temperature of the battery crossing the range junction point when the temperature of the battery changes from the first temperature range to the second temperature range; and charging the battery at the first charging rate in response to the temperature of the battery crossing the charging strategy switching point when the temperature of the battery changes from the second temperature range to the first temperature range.

5. The battery charging control method according to claim 2, wherein said determining, in response to the temperature of the battery being within the first temperature range, the charging strategy switching point based on the predetermined temperature hysteresis value and the range junction point comprises:
when the maximum value of the first temperature range is smaller than the predetermined temperature threshold, and a minimum value of the second temperature range is greater than the predetermined temperature threshold, determining a first charging strategy switching point based on a predetermined temperature hysteresis value corresponding to the first temperature range and the range junction point, and determining a second charging strategy switching point based on a predetermined temperature hysteresis value corresponding to the second temperature range and the range junction point,
and wherein said charging, when the temperature of the battery changes from the first temperature range to the second temperature range, the battery at the second charging rate in response to the temperature of the battery crossing one of the range junction point or the charging strategy switching point; and charging, when the temperature of the battery changes from the second temperature range to the first temperature range, the battery at the first charging rate in response to the temperature of the battery crossing the other one of the range junction point or the charging strategy switching point comprises:
charging, when the temperature of the battery changes from the first temperature range to the second temperature range, the battery at the second charging rate in response to the temperature of the battery crossing the first charging strategy switching point; and charging, when the temperature of the battery changes from the second temperature range to the first temperature range, the battery at the first charging rate in response to the temperature of the battery crossing the second charging strategy switching point.

6. The battery charging control method according to claim 3, wherein said determining, in response to the temperature of the battery being within the first temperature range, the charging strategy switching point based on the predetermined temperature hysteresis value and the range junction point comprises:
when the first temperature range is lower than the second temperature range and the maximum value of the first temperature range is smaller than the predetermined temperature threshold, adding the predetermined temperature hysteresis value to the maximum value of the first temperature range to obtain the charging strategy switching point; and
when the first temperature range is higher than the second temperature range and the minimum value of the first temperature range is greater than the predetermined temperature threshold, subtracting the predetermined temperature hysteresis value from the minimum value of the first temperature range to obtain the charging strategy switching point.

7. The battery charging control method according to claim 1, wherein a temperature range where the temperature of the battery resides comprises a plurality of third temperature ranges and a plurality of fourth temperature ranges, wherein:
the first temperature range is any one of the plurality of third temperature ranges or any one of the plurality of fourth temperature ranges;
a smaller difference between an average value of the third temperature range and the predetermined temperature threshold corresponds to a smaller predetermined temperature hysteresis value; and
a smaller difference between an average value of the fourth temperature range and the predetermined temperature threshold corresponds to a larger predetermined temperature hysteresis value.

8. The battery charging control method according to claim 4, wherein a ratio of the predetermined temperature hysteresis value to a range length of the first temperature range is a predetermined ratio ranging from 0.25 to 0.5, wherein the range length is a difference between the maximum value of the first temperature range and the minimum value of the first temperature range.

9. The battery charging control method according to claim 1, further comprising:
detecting whether fluctuation occurs in the temperature of the battery;
if the fluctuation occurs in the temperature of the battery, performing said determining, in response to the temperature of the battery being within the first temperature range, a charging strategy switching point based on a predetermined temperature hysteresis value and the range junction point;
if the fluctuation does not occur in the temperature of the battery, charging the battery at the first charging rate in response to the temperature of the battery being within the first temperature range, and charging the battery at the second charging rate in response to the temperature of the battery being within the second temperature range.

10. The battery charging control method according to claim 1, further comprising:
stopping charging when the temperature of the battery is smaller than a first temperature threshold, or greater than or equal to a second temperature threshold, wherein the first temperature threshold is smaller than the second temperature threshold.

11. The battery charging control method according to claim 1, wherein the predetermined temperature hysteresis value ranges from 1 degree Celsius to 5 degrees Celsius.

12. The battery charging control method according to claim 1, wherein:
a maximum value of the first temperature range is smaller than a predetermined temperature threshold; or
a minimum value of the second temperature range is greater than the predetermined temperature threshold.

13. The battery charging control method according to claim 1, wherein when the battery is a battery module or a battery pack, the temperature of the battery is determined based on temperatures of respective battery cells in the battery.

14. The battery charging control method according to claim 13, wherein the temperature of the battery is an average value, a median value, a maximum value, or a minimum value of the temperatures of the battery cells.

15. The battery charging control method according to claim 1, wherein said obtaining a temperature of a battery comprises obtaining the temperature of the battery using a temperature obtaining apparatus, wherein the temperature obtaining apparatus comprises a thermocouple temperature sensor, a thermal resistance temperature detector, an NTC thermistor temperature sensor, a radiation thermometer, an infrared thermal imager, or an ultrasonic thermometer.

16. An energy storage device, comprising:
a memory;
a processor; and
a computer program stored in the memory and executable on the processor, wherein the processor is configured to, when executing the program:
obtain a temperature of a battery; charge the battery at a first charging rate in response to the temperature of the battery being within a first temperature range, and charge the battery at a second charging rate in response to the temperature of the battery being within a second temperature range, wherein the first temperature range and the second temperature range are adjacent to each other and share a range junction point, and the first charging rate is different from the second charging rate;
determine, in response to the temperature of the battery being within the first temperature range, a charging strategy switching point based on a predetermined temperature hysteresis value and the range junction point; and
charge, when the temperature of the battery changes from the first temperature range to the second temperature range, the battery at the second charging rate in response to the temperature of the battery crossing one of the range junction point or the charging strategy switching point; and charge, when the temperature of the battery changes from the second temperature range to the first temperature range, the battery at the first charging rate in response to the temperature of the battery crossing another one of the range junction point or the charging strategy switching point.

17. The energy storage device according to claim 16, wherein the processor is configured to, when executing the program:
determine that the range junction point is smaller than the charging strategy switching point when a maximum value of the first temperature range is smaller than a predetermined temperature threshold; and
determine that the range junction point is greater than the charging strategy switching point when a minimum value of the first temperature range is greater than the predetermined temperature threshold.

18. The energy storage device according to claim 16, comprising at least one of a lithium-ion battery, a lead-acid battery, a nickel-metal hydride battery, a portable energy storage product, a household energy storage battery, and a vehicle power battery.

19. A non-transitory computer-readable storage medium, having a computer program stored thereon, wherein the computer program is configured to, when executed by a processor
obtain a temperature of a battery; charge the battery at a first charging rate in response to the temperature of the battery being within a first temperature range, and charge the battery at a second charging rate in response to the temperature of the battery being within a second temperature range, wherein the first temperature range and the second temperature range are adjacent to each other and share a range junction point, and the first charging rate is different from the second charging rate;
determine, in response to the temperature of the battery being within the first temperature range, a charging strategy switching point based on a predetermined temperature hysteresis value and the range junction point; and
charge, when the temperature of the battery changes from the first temperature range to the second temperature range, the battery at the second charging rate in response to the temperature of the battery crossing one of the range junction point or the charging strategy switching point; and charge, when the temperature of the battery changes from the second temperature range to the first temperature range, the battery at the first charging rate in response to the temperature of the battery crossing another one of the range junction point or the charging strategy switching point.

20. A computer program product, comprising a computer program, wherein the computer program is configured to, when executed by a processor, implement the battery charging control method according to any one of claim 1.
